(19) United States
(12) Patent Application Publication
(10) Pub. No.: US 2020/0036275 A1
(43) Pub. Date: Jan. 30, 2020

(54) LINEAR MOTOR

(71) Applicant: HIWIN MIKROSYSTEM CORP., Taichung (TW)

(72) Inventors: Hui-Ming CHEN, Taichung (TW); Sheng-Yu TSENG, Taichung (TW); Cheng-Te CHI, Taichung (TW); Chao-Chin TENG, Taichung (TW)

(73) Assignee: HIWIN MIKROSYSTEM CORP., Taichung (TW)

(21) Appl. No.: 16/047,211

(22) Filed: Jul. 27, 2018

(51) Int. Cl. H02K 41/03

(52) U.S. Cl. CPC H02K 41/031

(57) ABSTRACT

A linear motor includes a magnet seat, a magnet unit, a coil seat and a coil unit. The magnet unit is disposed on the magnet seat, and includes a plurality of magnet sets each including two magnets. The coil unit is disposed on the coil seat, and includes a plurality of coil sets each including two coils. The magnets of each of the magnet sets are aligned with each other in a direction different from that in which the coils of each of the coil sets are aligned.

### FIELD

The disclosure relates to a motor, and more particularly to a linear motor.

### BACKGROUND

Referring to FIG. 1, a conventional linear motor 1 is shown to include a magnet seat 11 that extends in a first direction (X), a plurality of magnet sets 12 that are disposed on the magnet seat 11 and that are arranged in the first direction (X), a coil seat 13, and a plurality of coil sets 14 that are disposed on the coil seat 13 and that are arranged in the first direction (X). The magnet seat 11 and the magnet sets 12 cooperatively serve as a stator of the conventional linear motor 1. The coil seat 13 and the coil sets 14 cooperatively serve as a forcer (i.e., the moving part) of the conventional linear motor 1.

The magnet seat 11 includes two magnet mounting portions 15 that are spaced apart from each other in a second direction (Y) perpendicular to the first direction (X). Each of the magnet sets 12 includes two magnets 16 that are respectively disposed on the magnet mounting portions 15 and that are aligned with each other in the second direction (Y) in an arrangement different from the magnets 16 of the neighboring magnet sets 12 in the first direction (X). The coil seat 13 includes two interconnected coil mounting portions 17 each of which is located between the magnet mounting portions 15 and extends in the first direction (X), and a plurality of tooth sets 18 that respectively correspond to the coil sets 14. Each of the tooth sets 18 includes two teeth 181 that respectively extend from the magnet mounting portions 17 and that are align with each other in the second direction (Y). Each of the coil sets 14 includes two coils 19 that respectively wound on the teeth 181 of the corresponding one of the tooth sets 18 and that are aligned with each other in the second direction (Y).

The two magnets 16 of each of the magnet sets 12 permanently form a magnetic field therebetween that is directed in the second direction (Y). When electric currents flow in the coil sets 14, the coil sets 14 are pushed by a continuous force in the first direction (X) so as to move the coil seat 13 relative to the magnet seat 11 in the first direction (X). In order to concentrate the magnetic flux at the center of each of the coils 19, each of the teeth 181 of the tooth sets 18 is made of high-permeability material (e.g., soft iron).

The magnitude of the attraction (or repulsion) occurring between a coil 19 and a magnet 16 increases as the distance between the coil 19 and the magnet 16 decreases. During the relative movement between the coil seat 13 and the magnet seat 11, when one of the coil 19 moves past any one of the magnet sets 12, the attraction (or repulsion) occurring therebetween would serve as a cogging force to suddenly accelerate or decelerate the coil seat 13 relative to the magnet seat 11, so as to affect the stability of the output of the conventional linear motor 1.

Moreover, since the magnets 16 of each of the magnet sets 12 are align with each other in the second direction (Y) and since the coils 19 of each of the coil sets 14 are align with each other in the second direction (Y), the cogging force occurring in the conventional linear motor 1 may reach nearly a tenth of the average continuous force of the conventional linear motor 1. As a result, the position of the forcer (i.e., the coil seat 13 and the coil sets 14) of the conventional linear motor 1 may not be controlled precisely.

### SUMMARY

Therefore, an object of the disclosure is to provide a linear motor that can alleviate at least one of the drawbacks of the prior art.

According to the disclosure, the linear motor includes a magnet seat, a magnet unit, a coil seat, a coil unit and a power transmission unit. The magnet unit is disposed on the magnet seat, and includes a plurality of magnet sets that are arranged in a first direction. An imaginary plane that is parallel to the first direction is defined. Each of the magnet sets includes two magnets that are respectively located at two opposite sides of the imaginary plane. Each of the magnets has a north pole and a south pole. For each of the magnet sets, the north pole of one of the magnets and the south pole of the other one of the magnets are proximate to the imaginary plane. The north pole of one of any two adjacent ones of the magnets of the magnet sets that are located at the same side of the imaginary plane and the south pole of the other one of the two adjacent ones of the magnets are proximate to the imaginary plane. A plurality of magnet lines of centers that respectively correspond to the magnet sets are defined. Each of the magnet lines of centers passes through the geometric centers of the magnets of the corresponding magnet set. Each of the magnet lines of centers is configured as one of a straight line and a bent line. The coil seat is disposed adjacent to the magnet seat. The coil unit is disposed on the coil seat, and includes a plurality of coil sets that are arranged in the first direction. Each of the coil sets includes two coils that are respectively located at the opposite sides of the imaginary plane. A plurality of coil lines of centers that respectively correspond to the coil sets are defined. Each of the coil lines of centers passes through the geometric centers of the coils of the corresponding coil set. Each of the coils surrounds the corresponding coil line of centers, and defines a magnetic flux space therein. Each of the coil lines of centers is configured as one of a straight line and a bent line. Each of the magnet lines of centers is configured as a straight line when each of the coil lines of centers is configured as a bent line. Each of the magnet lines of centers is configured as a bent line when each of the coil lines of centers is configured as a straight line. The power transmission unit is electrically connected to all of the coils.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary side view illustrating a conventional linear motor;

FIG. 2 is a fragmentary side view illustrating a first embodiment of the linear motor according to the disclosure;

FIG. 3 illustrates waveform of magnitude of the continuous force of the first embodiment against time;

FIG. 4 illustrates waveform of magnitude of the cogging force of the first embodiment against time;

FIG. 5 is a fragmentary side view illustrating a second embodiment of the linear motor according to the disclosure;

FIG. 6 is a fragmentary side view illustrating a third embodiment of the linear motor according to the disclosure; and

FIG. 7 is a fragmentary side view illustrating a fourth embodiment of the linear motor according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

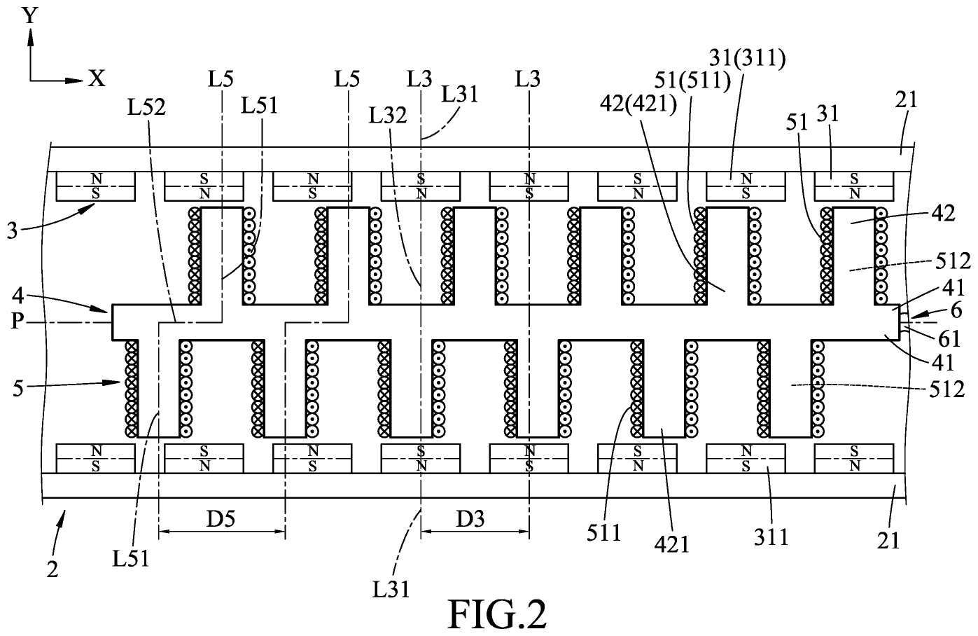

Referring to FIG. 2, the first embodiment of the linear motor according to the disclosure includes a magnet seat 2, a magnet unit 3, a coil seat 4, a coil unit 5 and a power transmission unit 6.

In the first embodiment, the magnet seat 2 and the magnet unit 3 cooperatively serve as a stator of the linear motor, and the coil seat 4 and the coil unit 5 cooperatively serve as a forcer (i.e., the moving part) of the linear motor. The magnet seat 2 includes two magnet mounting portions 21 each of which extends in a first direction (X). The magnet mounting portions 21 are spaced apart from each other in a second direction (Y) perpendicular to the first direction (X).

The magnet unit 3 is disposed on the magnet seat 2, and includes a plurality of magnet sets 31 that are arranged in the first direction (X). An imaginary plane (P) that is parallel to the first direction (X) is defined. The magnet mounting portions 21 of the magnet seat 2 are respectively located at two opposite sides of the imaginary plane (P). Each of the magnet sets 31 includes two magnets 311 that are respectively located at the opposite sides of the imaginary plane (P) and that are respectively disposed on the magnet mounting portions 21. Each of the magnets 311 has a north pole (N) and a south pole (S). For each of the magnet sets 31, the north pole (N) of one of the magnets 311 and the south pole (S) of the other one of the magnets 311 are proximate to the imaginary plane (P). The north pole (N) of one of any two adjacent ones of the magnets 311 of the magnet sets 31 that are located at the same side of the imaginary plane (P) and the south pole (S) of the other one of the two adjacent ones of the magnets 311 are proximate to the imaginary plane (P).

A plurality of magnet lines of centers (L3) that respectively correspond to the magnet sets 31 are defined. Each of the magnet lines of centers (L3) passes through the geometric centers of the magnets 311 of the corresponding magnet set 31, and has two passing sections (L31) that respectively pass through the geometric centers of the magnets 311 of the corresponding magnet set 31, and a connecting section (L32) that is connected between the passing sections (L31). In the first embodiment, each of the magnet lines of centers (L3) is configured as a straight line that extends in the second direction (Y). In other words, the passing sections (L31) and the connecting sections (L32) of each of the magnet lines of centers (L3) are aligned with each other in the second direction (Y).

The coil seat 4 is proximate to the magnet seat 2. In the first embodiment, the coil seat 4 has two interconnected coil mounting portions 41 each of which extends in the first direction (X), and a plurality of tooth sets 42 that are disposed on the coil mounting portions 41 and that are spaced apart from each other in the first direction (X). The coil mounting portions 41 of the coil seat 4 are located between the magnet mounting portions 21 of the magnet seat 2, and are respectively located at the opposite sides of the imaginary plane (P). Each of the tooth sets 42 includes two teeth 421 that respectively extend from the coil mounting portions 41 in the second direction (Y).

The coil unit 5 is disposed on the coil seat 4, and includes a plurality of coil sets 51 that are arranged in the first direction. Each of the coil sets 51 includes two coils 511 that are respectively located at the opposite sides of the imaginary plane (P) and that are respectively disposed on the coil mounting portions 41 of the coil seat 4. The magnets 311 and the coils 511 are located between the magnet mounting portions 21 of the magnet seat 2. The coil sets 51 respectively correspond to the tooth sets 42. The coils 511 of each of the coil sets 51 are respectively wound on the teeth 421 of the corresponding tooth set 42.

A plurality of coil lines of centers (L5) that respectively correspond to the coil sets 51 are defined. Each of the coil lines of centers (L5) passes through the geometric centers of the coils 511 of the corresponding coil set 51, and has two passing sections (L51) that respectively pass through the geometric centers of the coils 511 of the corresponding coil set 51, and a connecting section (L52) that is connected between the passing sections (L51). Each of the coils 511 surrounds the corresponding coil line of centers (L5), and defines a magnetic flux space 512 therein. In the first embodiment, each of the coil lines of centers (L5) is configured as a bent line. For each of the coil lines of centers (L5), each of the passing sections (L51) extends in the second direction (Y), and the connecting section (L52) extends in the first direction (X). The passing sections (L51) of each of the coil lines of centers (L5) are misaligned from each other.

Any two adjacent ones of the passing sections (L31) of the magnet lines of centers (L3) that are located at the same side of the imaginary plane (P) are spaced apart from each other in the first direction (X) by a magnet distance (D3). Any two adjacent ones of the passing sections (L51) of the coil lines of centers (L5) that are located at the same side of the imaginary plane (P) are spaced apart from each other in the first direction (X) by a coil distance (D5). In the first embodiment, the length of the connecting section (L52) of each of the coil lines of centers (L5) is not shorter than a sixth of the magnet distance (D3) and is not longer than five sixths of the magnet distance (D3). Preferably, the length of the connecting section (L52) of each of the coil lines of centers (L5) is a half of the magnet distance (D3).

The power transmission unit 6 is electrically connected to all of the coils 511. In the first embodiment, the power transmission unit 6 includes, but is not limited to, a composite cable 61 that has an end electrically connected to all of the coils 511, and another end electrically connected to a power source (not shown).

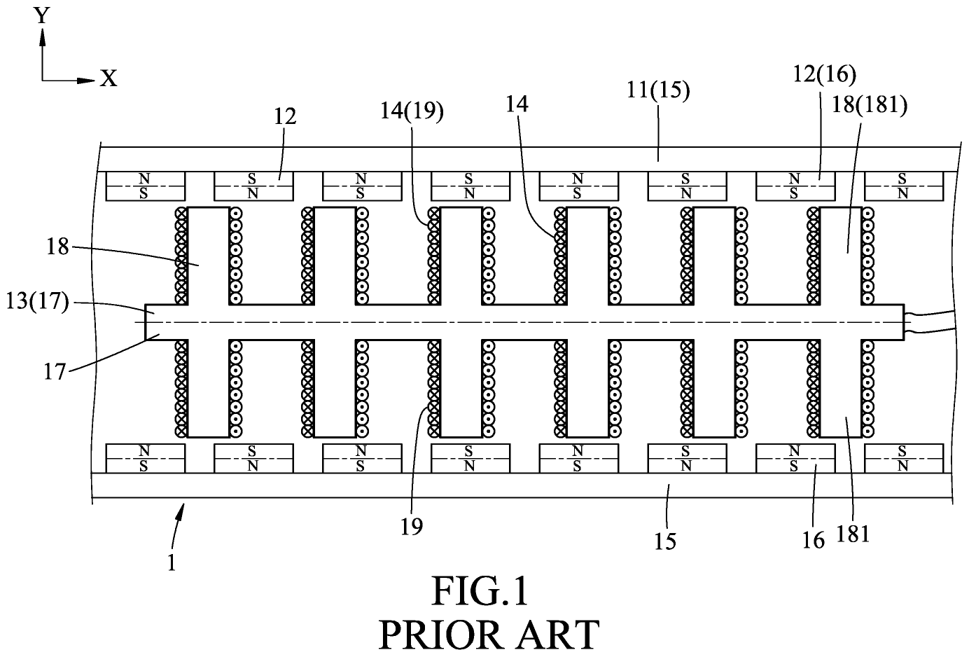

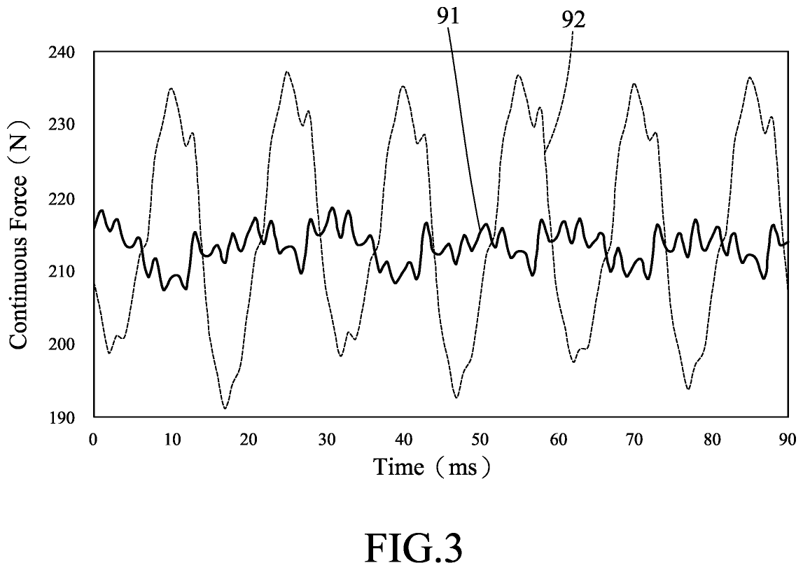

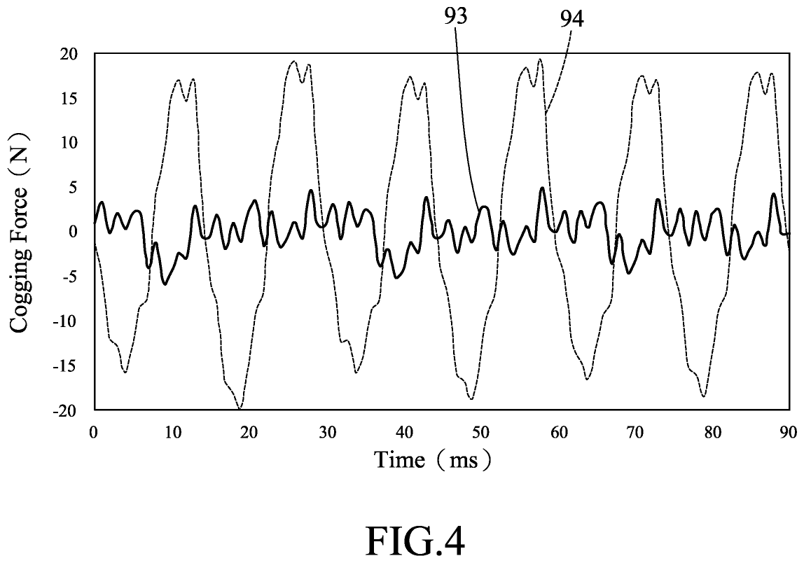

Referring to FIGS. 3 and 4, waveform 91 illustrates the magnitude of the continuous force of the linear motor according to the disclosure against time, waveform 92 illustrates the magnitude of the continuous force of the conventional linear motor 1 (see FIG. 1) against time, waveform 93 illustrates the magnitude of the cogging force of the linear motor according to the disclosure against time, and waveform 94 illustrates the magnitude of the cogging force of the conventional linear motor 1 against time. The average continuous force of the conventional linear motor 1 is 215 N (newton), and the maximum cogging force of the conventional linear motor 1 is 19.06 N. The average continuous force of the linear motor according to the disclosure is 213 N, and is close to that of the conventional linear motor 1. However, the maximum cogging force of the linear motor according to the disclosure is 4.78 N, and is reduced by 75 percent compared with that of the conventional linear motor 1.

Moreover, the RMS (root mean square) cogging force of the conventional linear motor 1 is 12.6 N, and the RMS cogging force of the linear motor according to the disclosure is 2.34 N. Therefore, the ripple percentage (the RMS cogging force divided by the average continuous force) of the conventional linear motor 1 is 5.86%. The ripple percentage of the linear motor according to the disclosure is 1.1%, and is much lower than that of the conventional linear motor 1, so that the output of the linear motor according to the disclosure is more stable.

According to the above, the advantages of the disclosure are as follows:

1. Since each of the magnet lines of centers (L3) is configured as a straight line (i.e., the magnets 311 of each of the magnet sets 31 are aligned with each other in the second direction (Y)), and since each of the coil lines of centers (L5) is configured as a bent line (i.e., the coils 511 of each of the coil sets 51 are misaligned from each other), the coils 511 of each of the coil sets 51 would not simultaneously aligned with the magnets 311 of any one of the magnet sets 31. As a result, the cogging force of the linear motor is considerably lowered, and the position of the forcer (i.e., the coil seat 4 and the coil unit 5) of the linear motor can be controlled more precisely.

2. Since the length of the connecting section (L52) of each of the coil lines of centers (L5) is not shorter than a sixth of the magnet distance (D3) and is not longer than five sixths of the magnet distance (D3), the cogging forces occurring at the opposite sides of the imaginary plane (P) may be partially balanced. On the occasion that the length of the connecting section (L52) of each of the coil lines of centers (L5) is a half of the magnet distance (D3), the cogging forces occurring at the opposite sides of the imaginary plane (P) may be greatly balanced so as to considerably lower the resultant cogging force of the linear motor.

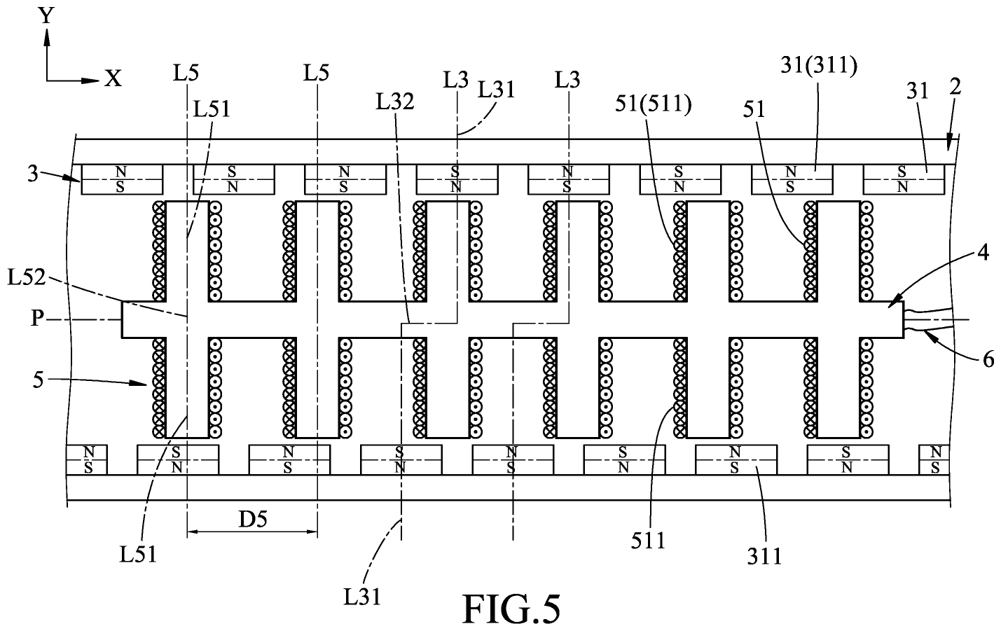

Referring to FIG. 5, the second embodiment of the linear motor according to the disclosure is similar to the first embodiment.

In the second embodiment, each of the magnet lines of centers (L3) is configured as a bent line, and each of the coil lines of centers (L5) is configured as a straight line. For each of the magnet lines of centers (L3), each of the passing sections (L31) extends in the second direction (Y), and the connecting section (L32) extends in the first direction (X) (i.e., magnets 311 of each of the magnet sets 31 are misaligned from each other). The passing sections (L51) and the connecting section (L52) of each of the coil lines of centers (L5) are aligned with each other in the second direction (Y) (i.e., the coils 511 of each of the coil sets 51 are aligned with each other in the second direction (Y)).

The length of the connecting section (L32) of each of the magnet lines of centers (L3) is not shorter than a sixth of the coil distance (D5) and is not longer than five sixths of the coil distance (D5). Preferably, the length of the connecting section (L32) of each of the magnet lines of centers (L3) is a half of the coil distance (D5).

As such, the second embodiment has advantages the same as those of the first embodiment. Moreover, since the coil seat 4 is symmetric with respect to the imaginary plane (P), a mold for manufacturing the coil seat 4 is relatively easy to be made, and the second embodiment has a relatively low manufacturing cost.

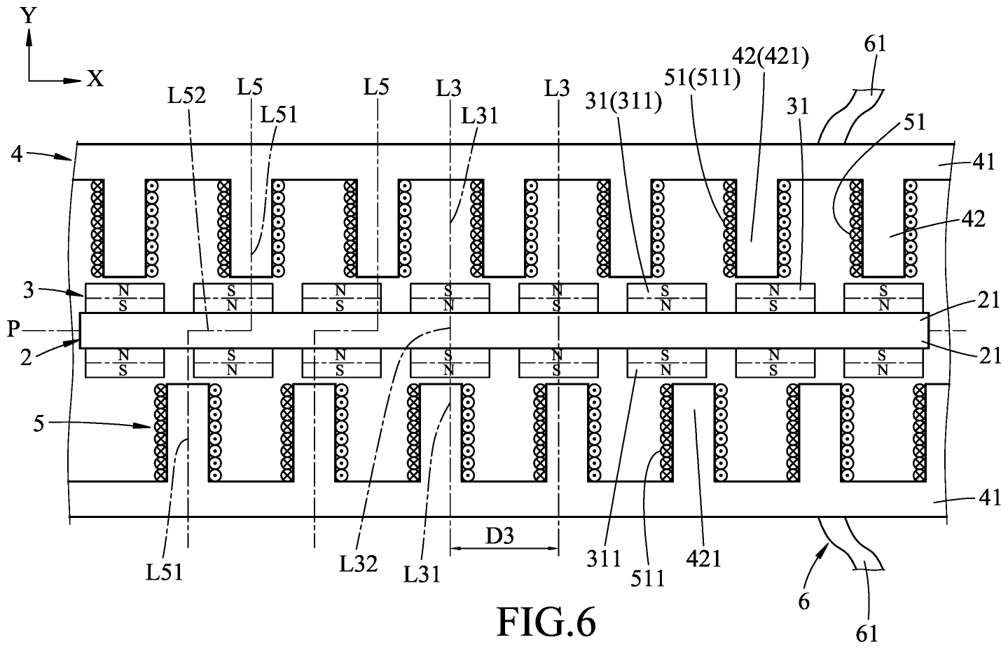

Referring to FIG. 6, the third embodiment of the linear motor according to the disclosure is similar to the first embodiment. The magnet seat 2 and the magnet unit 3 cooperatively serve as the forcer (i.e., the moving part) of the third embodiment, and the coil seat 4 and the coil unit 5 cooperatively serve as the stator of the third embodiment.

The magnet seat 2 includes two interconnected magnet mounting portions 21 that extend in the first direction (X) and that are respectively located at the opposite sides of the imaginary plane (P). The magnets 311 of each of the magnet sets 31 are respectively disposed on the magnet mounting portions 21.

Each of the magnet lines of centers (L3) is configured as a straight line that extends in the second direction (Y). The passing sections (L31) and the connecting sections (L32) of each of the magnet lines of centers (L3) are aligned with each other in the second direction (Y). In other words, the magnets 311 of each of the magnet sets 31 are aligned with each other in the second direction (Y).

The coil seat 4 includes two spaced-apart coil mounting portions 41 that extend in the first direction (X) and that are respectively located at the opposite sides of the imaginary plane (P), and a plurality of tooth sets 42 that are disposed on the coil mounting portions 41 and that are spaced apart from each other in the first direction (X). The magnet mounting portions 21 are located between the coil mounting portions 41. Each of the tooth sets 42 includes two teeth 421 that respectively extend from the coil mounting portions 41 in the second direction (Y).

The coils 511 of each of the coil sets 51 are respectively disposed on the coil mounting portions 41. The magnets 311 and the coils 511 are located between the coil mounting portions 41. The tooth sets 42 respectively correspond to the coil sets 51. The coils 511 of each of the coil sets 51 are respectively wound on the teeth 421 of the corresponding tooth set 42.

Each of the coil lines of centers (L5) is configured as a bent line. For each of the coil lines of centers (L5), each of the passing sections (L51) extends in the second direction (Y), and the connecting section (L52) extends in the first direction (X). The passing sections (L51) of each of the coil lines of centers (L5) are misaligned from each other. The coils 511 of each of the coil sets 51 are misaligned from each other.

The length of the connecting section (L52) of each of the coil lines of centers (L5) is not shorter than a sixth of the magnet distance (D3) and is not longer than five sixths of the magnet distance (D3). Preferably, the length of the connecting section (L52) of each of the coil lines of centers (L5) is a half of the magnet distance (D3).

The power transmission unit 6 includes, but is not limited to, two composite cables 61 each of which is electrically connected to all of the coils 511 at a respective one of the opposite sides of the imaginary plane (P).

As such, the third embodiment has advantages the same as those of the first embodiment. In addition, since the magnet seat 2 and the magnet unit 3 cooperatively serve as the forcer, the forcer of the third embodiment is relatively light, and can work without consideration of the arrangement of the composite cables 61 and heat dissipation. Moreover, forcer of the third embodiment is easy to be assembled.

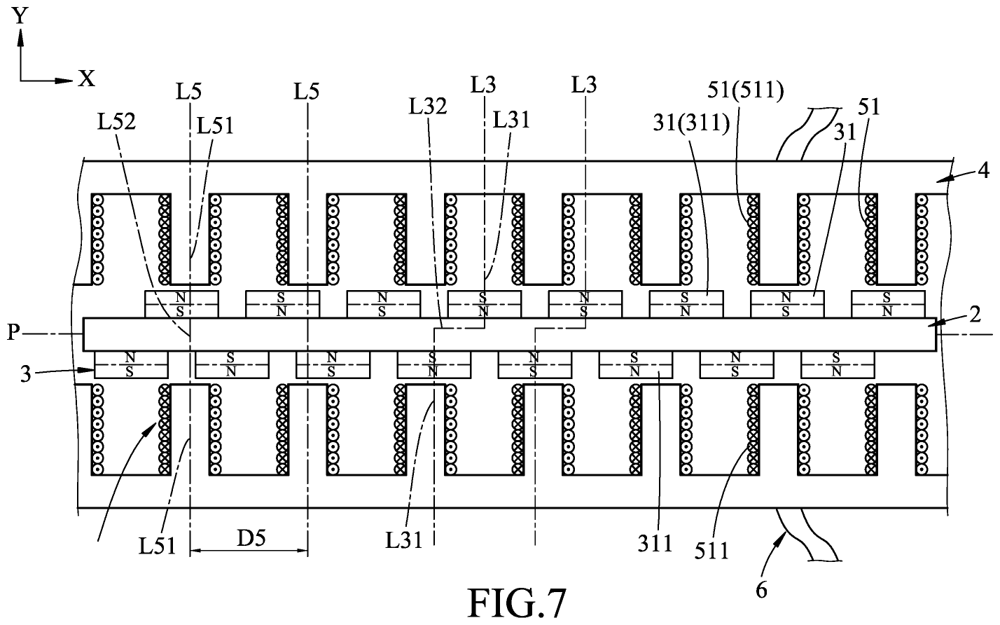

Referring to FIG. 7, the fourth embodiment is similar to the third embodiment.

In the fourth embodiment, each of the magnet lines of centers (L3) is configured as a bent line, and each of the coil lines of centers (L5) is configured as a straight line. For each of the magnet lines of centers (L3), each of the passing sections (L31) extends in the second direction (Y), and the connecting section (L32) extends in the first direction (X) (i.e., magnets 311 of each of the magnet sets 31 are misaligned from each other).

The passing sections (L51) and the connecting section (L52) of each of the coil lines of centers (L5) are aligned with each other in the second direction (Y) (i.e., the coils 511 of each of the coil sets 51 are aligned with each other in the second direction (Y)).

The length of the connecting section (L32) of each of the magnet lines of centers (L3) is not shorter than a sixth of the coil distance (D5) and is not longer than five sixths of the coil distance (D5). Preferably, the length of the connecting section (L32) of each of the magnet lines of centers (L3) is a half of the coil distance (D5).

As such, the fourth embodiment has advantages the same as those of the first embodiment.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A linear motor comprising:
a magnet seat;
a magnet unit disposed on said magnet seat, and including a plurality of magnet sets that are arranged in a first direction, an imaginary plane that is parallel to the first direction being defined, each of said magnet sets including two magnets that are respectively located at two opposite sides of the imaginary plane, each of said magnets having a north pole and a south pole, for each of said magnet sets, said north pole of one of said magnets and said south pole of the other one of said magnets being proximate to the imaginary plane, said north pole of one of any two adjacent ones of said magnets of said magnet sets that are located at the same side of the imaginary plane and said south pole of the other one of said two adjacent ones of said magnets being proximate to the imaginary plane, a plurality of magnet lines of centers that respectively correspond to said magnet sets being defined, each of said magnet lines of centers passing through the geometric centers of said magnets of said corresponding magnet set, each of said magnet lines of centers being configured as one of a straight line and a bent line;
a coil seat disposed adjacent to said magnet seat;
a coil unit disposed on said coil seat, and including a plurality of coil sets that are arranged in the first direction, each of said coil sets including two coils that are respectively located at the opposite sides of the imaginary plane, a plurality of coil lines of centers that respectively correspond to said coil sets being defined, each of said coil lines of centers passing through the geometric centers of said coils of said corresponding coil set, each of said coils surrounding said corresponding coil line of centers, and defining a magnetic flux space therein, each of said coil lines of centers being configured as one of a straight line and a bent line, each of said magnet lines of centers being configured as a straight line when each of said coil lines of centers is configured as a bent line, each of said magnet lines of centers being configured as a bent line when each of said coil lines of centers is configured as a straight line; and
a power transmission unit electrically connected to all of said coils.

2. The linear motor as claimed in claim 1, wherein each of said magnet lines of centers has two passing sections that respectively pass through the geometric centers of said magnets of said corresponding magnet set, and a connecting section that is connected between said passing sections, when each of said magnet lines of centers is configured as a straight line, said passing sections and said connecting sections of each of said magnet lines of centers being aligned with each other in a second direction perpendicular to the first direction, when each of said magnet lines of centers is configured as a bent line, said passing sections of each of said magnet lines of centers extending in the second direction and said connecting sections of each of said magnet lines of centers extending in the first direction, each of the coil lines of centers having two passing sections that respectively pass through the geometric centers of said coils of said corresponding coil set, and a connecting section that is connected between said passing sections, when each of said coil lines of centers is configured as a straight line, said passing sections and said connecting sections of each of said coil lines of centers being aligned with each other in the second direction, when each of said coil lines of centers is configured as a bent line, said passing sections of each of said coil lines of centers extending in the second direction and said connecting sections of each of said coil lines of centers extending in the first direction.

3. The linear motor as claimed in claim 2, wherein each of said magnet lines of centers is configured as a straight line, and each of said coil lines of centers is configured as a bent line, said magnet seat including two magnet mounting portions each of which extends in the first direction, said magnet mounting port ions being spaced apart from each other in the second direction and being respectively located at the opposite sides of the imaginary plane, said magnets of each of said magnet sets being respectively disposed on said magnet mounting portions, said coil seat having two interconnected coil mounting portions each of which extends in the first direction, said coil mounting portions of said coil seat being located between said magnet mounting portions of said magnet seat, and being respectively located at the opposite sides of the imaginary plane, said coils of each of said coil sets being respectively disposed on said coil mounting portions, said magnets and said coils being located between said magnet mounting portions.

4. The linear motor as claimed in claim 2, wherein each of said magnet lines of centers is configured as a bent line, and each of said coil lines of centers is configured as a straight line, said magnet seat including two magnet mounting portions each of which extends in the first direction, said magnet mounting portions being spaced apart from each other in the second direction and being respectively located at the opposite sides of the imaginary plane, said magnets of each of said magnet sets being respectively disposed on said magnet mounting portions, said coil seat having two interconnected coil mounting portions each of which extends in the first direction, said coil mounting portions of said coil seat being located between said magnet mounting portions of said magnet seat, and being respectively located at the opposite sides of the imaginary plane, said coils of each of said coil sets being respectively disposed on said coil mounting portions, said magnets and said coils being located between said magnet mounting portions.

5. The linear motor as claimed in claim 2, wherein each of said magnet lines of centers is configured as a straight line, and each of said coil lines of centers is configured as a bent line, said magnet seat including two interconnected magnet mounting portions each of which extends in the first direction, said magnet mounting portions being respectively located at the opposite sides of the imaginary plane, said magnets of each of said magnet sets being respectively disposed on said magnet mounting portions, said coil seat including two coil mounting portions each of which extends in the first direction, said coil mounting portions of said coil seat being spaced apart from each other in the second direction, and being respectively located at the opposite sides of the imaginary plane, said coils of each of said coil sets being respectively disposed on said coil mounting portions, said magnet mounting portions of said magnet seat being located between said coil mounting portions of said coil seat, said magnets and said coils being located between said coil mounting portions.

6. The linear motor as claimed in claim 2, wherein each of said magnet lines of centers is configured as a bent line, and each of said coil lines of centers is configured as a straight line, said magnet seat including two interconnected magnet mounting portions each of which extends in the first direction, said magnet mounting portions being respectively located at the opposite sides of the imaginary plane, said magnets of each of said magnet sets being respectively disposed on said magnet mounting portions, said coil seat including two coil mounting portions each of which extends in the first direction, said coil mounting portions of said coil seat being spaced apart from each other in the second direction, and being respectively located at the opposite sides of the imaginary plane, said coils of each of said coil sets being respectively disposed on said coil mounting portions, said magnet mounting portions of said magnet seat being located between said coil mounting portions of said coil seat, said magnets and said coils being located between said coil mounting portions.

7. The linear motor as claimed in claim 3, wherein said coil seat further has a plurality of tooth sets that are disposed on said coil mounting portions, that are spaced apart from each other in the first direction, and that respectively correspond to said coil sets, each of said tooth sets including two teeth that respectively extend from said coil mounting portions in the second direction, said coils of each of said coil sets being respectively wound on said teeth of said corresponding tooth set.

8. The linear motor as claimed in claim 4, wherein said coil seat further has a plurality of tooth sets that are disposed on said coil mounting portions, that are spaced apart from each other in the first direction, and that respectively correspond to said coil sets, each of said tooth sets including two teeth that respectively extend from said coil mounting portions in the second direction, said coils of each of said coil sets being respectively wound on said teeth of said corresponding tooth set.

9. The linear motor as claimed in claim 5, wherein said coil seat further has a plurality of tooth sets that are disposed on said coil mounting portions, that are spaced apart from each other in the first direction, and that respectively correspond to said coil sets, each of said tooth sets including two teeth that respectively extend from said coil mounting portions in the second direction, said coils of each of said coil sets being respectively wound on said teeth of said corresponding tooth set.

10. The linear motor as claimed in claim 6, wherein said coil seat further has a plurality of tooth sets that are disposed on said coil mounting portions, that are spaced apart from each other in the first direction, and that respectively correspond to said coil sets, each of said tooth sets including two teeth that respectively extend from said coil mounting portions in the second direction, said coils of each of said coil sets being respectively wound on said teeth of said corresponding tooth set.

11. The linear motor as claimed in claim 2, wherein any two adjacent ones of said passing sections of said magnet lines of centers that are located at the same side of the imaginary plane are spaced apart from each other in the first direction by a magnet distance, and any two adjacent ones of said passing sections of said coil lines of centers that are located at the same side of the imaginary plane are spaced apart from each other in the first direction by a coil distance, when each of said magnet lines of centers is configured as a bent line, the length of the connecting section of each of the magnet lines of centers being not shorter than a sixth of the coil distance and being not longer than five sixths of the coil distance, when each of said coil lines of centers is configured as a bent line, the length of said connecting section of each of said coil lines of centers being not shorter than a sixth of the magnet distance and being not longer than five sixths of the magnet distance.
